(19) United States
(12) Patent Application Publication
(10) Pub. No.: US 2016/0147863 A1
(43) Pub. Date: May 26, 2016

(54) TOPIC BASED CLASSIFICATION OF DOCUMENTS

(71) Applicant: HEWLETT-PACKARD DEVELOPMENT COMPANY, L.P., Houston, TX (US)

(72) Inventors: Raghu Anantharangachar, Bangalore Karnataka (IN); Pradeep Chourasiya, Bangalore Karnataka (IN); Viswanathan Kapaleeswaran, Bangalore (IN); Dixit Sudhir, Bangalore (IN)

(21) Appl. No.: 14/897,308

(22) PCT Filed: Jun. 24, 2013
(86) PCT No.: PCT/IN2013/000390

§ 371 Date: Dec. 10, 2015

(51) Int. Cl. G06F 17/30

(52) U.S. Cl. CPC G06F 17/30598; G06F 17/3053

(57) ABSTRACT

Systems and methods for classification of documents based on topic to which the documents pertain are described herein. In one implementation, the method comprises computing a probability of a document being topical based on a number of constituent elements that are topical and a total number of constituent elements and computing a probability of the document being anti-topical based on a number of constituent elements that are anti-topical and the total number of constituent elements. The method further comprises determining whether the probability of the document being topical is greater than the probability of the document being anti-topical. Thereafter, the method includes classifying the document as topical on determining the probability of the document being topical to be greater than the probability of the document being anti-topical.

### BACKGROUND

Generally, document repositories are extensively used to store documents, such as webpages, pertaining to various topics. A variety of web based applications are available which facilitate the users to search and browse various documents that may be of interest to the users. For example, online product review portals may facilitate the users to browse documents related to product descriptions, product reviews and other information that is related to the product in which the user may be interested. In order to provide improved browsing and searching experiences for users, various techniques of classification of documents are implemented to allow users to locate the documents of their interest.

Classifying documents is a complex task as the documents, especially webpages, do not have any defined structure and are dynamic. Thus, in many cases a document may be misclassified or classified under multiple categories without having sufficient relevancy in any particular category. These diminish the usefulness of the document and reduce the user browsing and searching experience.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the figures to reference like features and components:

FIG. 1a schematically illustrates a document classification system, according to an example of the present subject matter.

FIG. 1b schematically illustrates the document classification system in a network environment, according to another example of the present subject matter.

FIG. 2a illustrates a method for document classification, according to an example of the present subject matter.

FIG. 2b illustrates a method for document classification, according to another example of the present subject matter.

FIG. 2c illustrates a method for document classification, according to another example of the present subject matter.

FIG. 2d illustrates a method for document classification, according to another example of the present subject matter.

FIG. 3 illustrates a computer readable medium storing instructions for document classification, according to an example of the present subject matter.

### DETAILED DESCRIPTION

The present subject matter relates to systems and methods for document classification. The methods and the systems as described herein may be implemented using various commercially available computing systems.

There are many general purpose document repositories that digitize human knowledge about many topics. These repositories have served as important sources of reference to societies and institutions doing research in those particular topics. For example, the Council of Scientific and Industrial Research (CSIR) and Department of Ayurveda set up the traditional knowledge digital library in India which serves as a knowledge repository of the traditional knowledge on Indians regarding medicinal plants and formulations used in Indian systems of medicine.

In many cases, a user who is interested in a topic may want to identify topical documents stored in a given document repository. For example, a user who is interested in programming may wish to identify all articles which are related to programming and are present in a document repository, such as Wikipedia.

Identifying all documents which are relevant for a particular topic, also referred to as topical documents, is a challenging task. Most of the commercially available document classifiers have less than satisfactory accuracy level in classification of documents. These classifiers classify a document into one or more topics based on the presence of certain keywords, metadata, tags and key-phrases. Further, these classifiers assign equal weightage to all the keywords and key-phrases. This results in many documents which are irrelevant for a topic being classified as relevant for the topic.

The systems and the methods, described herein, implement classification of documents, in a document repository, based on the topic to which the documents pertain. In one example, the method of document classification is implemented using a document classification system. The document classification system may be implemented by any computing system, such as personal computers, network servers and servers.

For initial setup, a user may examine a small set of documents, such as ten documents, from a document repository to identify certain keywords, referred to as topical words, which indicate that a document pertains to a particular topic. Further, the user may also identify certain anti-keywords, referred to as anti-topical words, which indicate that a document does not pertain to the particular topic. The identified topical and anti-topical keywords are then fed to the document classification system.

In operation, the document classification system parses each document into a set of paragraphs, which may be further broken down into a set of sentences. In one example, the sentences may further be broken down into words. The document classification may parse the document into its constituent elements, such as paragraphs, sentences and words, based on formatting elements, such as paragraph mark, new line character and full-stop, present in the document.

The document classification system then determines the total number of constituent elements in the document, which is represented by N_{CE}. Based on the identified topical and anti-topical keywords, the document classification system determines the number of topical constituent elements, which is represented by N_{TCE}, and number of anti-topical constituent elements, which is represented by N_{ATCE}.

Based on the number of topical constituent elements and the total number of constituent elements in the document, the document classification system determines a probability, represented by P_{TD}, of the document being topical. Similarly, based on the number of number of anti-topical constituent elements and the total number of constituent elements in the document, the document classification system determines a probability, represented by P_{ATD}, of the document being anti-topical.

If the document classification system determines that for a document, the P_{TD} is greater than the P_{ATD}, then the document classification system classifies the document to be topical. On the other hand, if for a document the P_{TD} is less than the P_{ATD}, the document is classified to be anti-topical. If the P_{TD} and P_{ATD} are equal, then the document classification system may raise a flag and request the user to provide inputs for classifying the document. In another example, if the P_{TD} and P_{ATD} are equal, then the document classification system may classify the document to be topical or anti-topical based on pre-defined classification rules.

In one example, the user may pre-select options, such that the document classification system uses one of words, sentences, and paragraphs as the constituent element to be considered for the purpose of classifying the document as topical or anti-topical. Further, the document classification system may apply different weightage to different constituent elements.

Thus, the systems and the methods, described herein, facilitate document classification of documents present in a repository based on topics to which the documents pertain. The document classification system, as described herein, provides different weightage to different constituent elements leading to enhanced accuracy in classification of documents. This may lead to faster search results and/or retrieval of documents in response to any user query. Further, the document classification system may also arrange the documents in a descending order of relevancy based on the difference between P_{TO} and P_{ATD}.

The above systems and the methods are further described in conjunction with the following figures. It should be noted that the description and figures merely illustrate the principles of the present subject matter. Further, various arrangements may be devised that, although not explicitly described or shown herein, embody the principles of the present subject matter and are included within its spirit and scope.

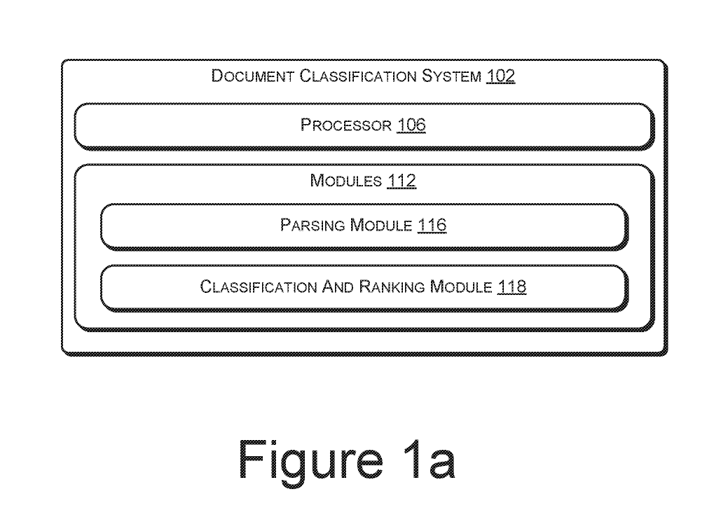

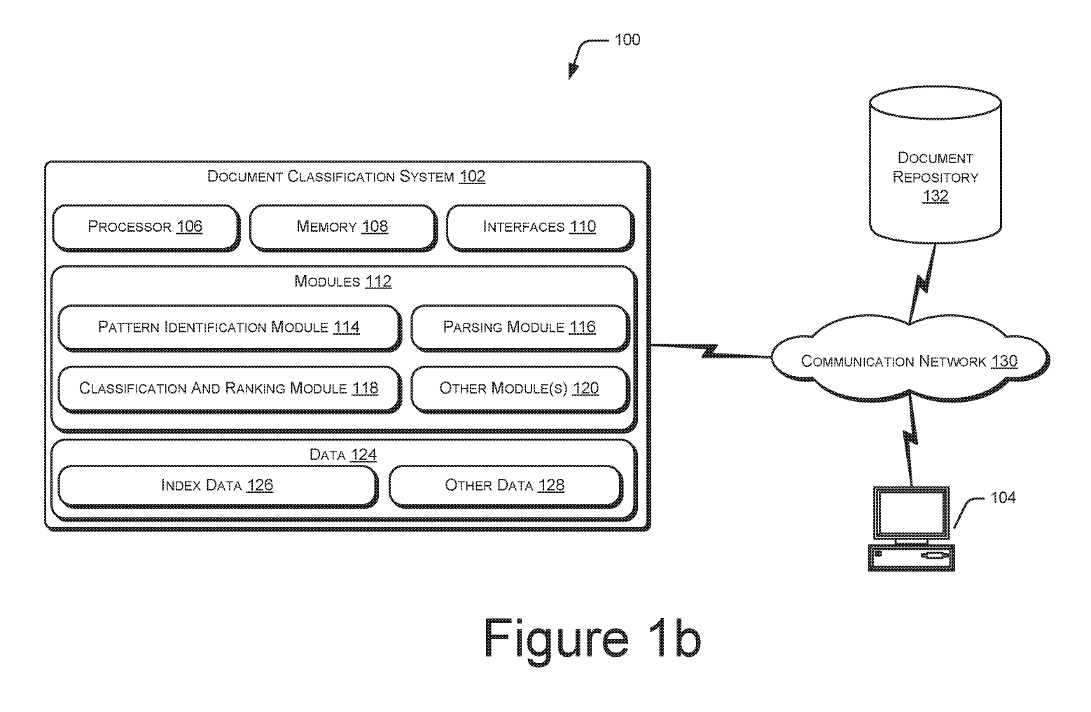

The manner in which the systems and methods for document classification are implemented are explained in details with respect to FIGS. 1a, 1b, 2a, 2b, 2c, 2d and 3. While aspects of described systems and methods for document classification can be implemented in any number of different computing systems, environments, and/or implementations, the examples and implementations are described in the context of the following system(s).

FIG. 1a schematically illustrates the components of a document classification system 102, according to an example of the present subject matter. In one example, the document classification system 102 may be implemented as any commercially available computing system.

In one implementation, the document classification system 102 includes a processor 106 and modules 112 communicatively coupled to the processor 106. The modules 112, amongst other things, include routines, programs, objects, components, and data structures, which perform particular tasks or implement particular abstract data types. The modules 112 may also be implemented as, signal processor(s), state machine(s), logic circuitries, and/or any other device or component that manipulates signals based on operational instructions. Further, the modules 112 can be implemented by hardware, by computer-readable instructions executed by a processing unit, or by a combination thereof. In one implementation, the modules 112 include a parsing module 116 and a classification and ranking module 118.

In one example, the parsing module 116 parses a document into its constituent elements. The constituent elements may be at least one of words, sentences and paragraphs. The parsing module 116 determines a total number of constituent elements in the document. Based on the key patterns received from a user, the parsing module 116 determines a number of constituent elements that are topical and a number of constituent elements that are anti-topical. Thereafter, the classification and ranking module 118 computes a probability of the document being topical based on the number of constituent elements that are topical and the total number of constituent elements. The classification and ranking module 118 also computes a probability of the document being anti-topical based on the number of constituent elements that are anti-topical and the total number of constituent elements.

The classification and ranking module 118 determines whether the probability of the document being topical is greater than the probability of the document being anti-topical. If the probability of the document being topical is greater than the probability of the document being anti-topical, the classification and ranking module 118 classifies the document as topical. The operation of the document classification system 102 is described in detail in conjunction with FIG. 1b.

FIG. 1b schematically illustrates a network environment 100 including the document classification system 102 according to another example of the present subject matter. The document classification system 102 may be implemented in various commercially available computing systems, such as personal computers, servers and network servers. The document classification system 102 may be communicatively coupled to various client devices 104, which may be implemented as personal computers, workstations, laptops, netbook, smart-phones and so on.

In one implementation, the document classification system 102 includes a processor 106, and a memory 108 connected to the processor 106. Among other capabilities, the processor 106 may fetch and execute computer-readable instructions stored in the memory 108.

The memory 108 may be communicatively coupled to the processor 106. The memory 108 can include any commercially available non-transitory computer-readable medium including, for example, volatile memory, and/or non-volatile memory.

Further, the document classification system 102 includes various interfaces 110. The interfaces 110 may include a variety of commercially available interfaces, for example, interfaces for peripheral device(s), such as data input and output devices, referred to as I/O devices, storage devices, and network devices. The interfaces 110 facilitate the communication of the document classification system 102 with various communication and computing devices and various communication networks.

Further, the document classification system 102 may include the modules 112. In said implementation, the modules 112 include a Pattern identification module 114, a parsing module 116, a classification and ranking module 118 and other module(s) 120. The other module(s) 120 may include programs or coded instructions that supplement applications or functions performed by the document classification system 102.

In an example, the document classification system 102 includes data 124. In said implementation, the data 124 may include an index data 126 and other data 128. The other data 128 may include data generated and saved by the modules 112 for providing various functionalities of the document classification system 102.

In one implementation, the document classification system 102 may be communicatively coupled to a document repository 132 over a communication network 130. The document repository 132 may be implemented as one or more computing systems and/or databases which store a plurality of documents pertaining to various topics. In one example, the document repository 132 may be integrated with the document classification system 102.

The communication network 130 may include a Global System for Mobile Communication (GSM) network, a Universal Mobile Telecommunications System (UMTS) network, or any other communication network that use any of the commonly used protocols, for example, Hypertext Transfer Protocol (HTTP) and Transmission Control Protocol/Internet Protocol (TCP/IP).

For initial setup, a user may use the pattern identification module 114 to examine a small set of documents, such as ten documents, from a document repository 132 to identify certain keywords, referred to as topical words, which indicate that a document pertains to a particular topic. Further, the user may also identify certain anti-keywords, referred to as anti-topical words, which indicate that a document does not pertain to the particular topic.

For example, the topic selected is human services. In said example, the user may use the pattern identification module 114 to go through a small set of documents, for example say ten documents, and identify what are the key patters, i.e., the patterns and anti-patterns that specify how to identify the topic. In one example, the patterns may be keywords or key-phrases which are related to the topic. An example of topical patterns describing human services may be {Person, Professional, Tradesperson, Tradesman, Expert, Practitioner, Craftsperson, Craftsman, Worker, Artisan, Amateur, Executive, Individual, Officer, Administrator, Artist and Manager}. An example of anti-patterns, in form of anti-keywords and anti-key-phrases, specifying non-human services may be {Born, Die, Died, Father, Mother, Son, Daughter, Wife, Husband, Parents, Children, Uncle, Untie, lives in, located in}. In one example, the topical patterns and anti-patterns may be stored by the pattern identification module 114 as index data 126.

In operation, the parsing module 116 retrieves each document from the data repository 132 and parses each of the documents into its constituent elements, such as paragraph, sentences and words. In one example, the parsing module 116 may parse the document based on formatting elements, such as paragraph mark, new line character and full-stop, present in the document. The parsing module 116 may be operated to classify the document as either of topical or anti-topical based on one of the constituent elements.

In one example, the parsing module 116 may classify the documents as one of topical and anti-topical based on words. In said example, the parsing module 116 determines the total number of words in the documents and the same is represented by N_{Words}. The parsing module 116 further determines the number of words that are topical and the same is represented by N_{TWords}. The parsing module 116 also determines the number of anti-topical words and the same is represented by N_{ATWords}.

Thereafter, the classification and ranking module 118 determines the probability of document being topical which is represented by P_{TD}. In one example, the P_{TD} is determined as per equation 1 provided below:

$${P}_{TD} = \frac{{N}_{TWords}}{{N}_{Words}} \qquad Equation 1$$

Further, the classification and ranking module 118 determines the probability of document being anti-topical which is represented by P_{ATD}. In one example, the P_{ATD} is determined as per equation 2 provided below:

$${P}_{ATD} = \frac{{N}_{ATWords}}{{N}_{Words}} \qquad Equation 2$$

Thereafter, if the P_{TD} is greater than the P_{ATD}, then the classification and ranking module 118 determines the document to be topical. In case, the P_{TD} is less than the P_{ATD}, then the classification and ranking module 118 determines the document to be anti-topical. In one example, if the P_{TD} and the P_{ATD} are equal, then the classification and ranking module 118 may raise a flag indicating the user to decide whether the document is topical or anti-topical. In another example, the classification and ranking module 118 may perform analysis on a different constituent element of the document on the P_{TD} and the P_{ATD} being equal. The classification and ranking module 118 may further rank the documents, classified as topical, in an order of relevance based on a descending order of the difference between P_{TD} and P_{ATD}.

In another example, the parsing module 116 may classify the documents as one of topical and anti-topical based on sentences. In said example, the parsing module 116 determines the total number of sentences in the documents and the same is represented by N_{Sentences}. The parsing module 116 further determines the number of words that are present in each sentence. The number of words in the i^{th} sentence is represented by N_{iWords}.

The parsing module 116 further determines the number of topical words in the i^{th} sentence, and the same is represented by N_{iTWords}. The parsing module 116 also determines the number of anti-topical words in the i^{th} sentence, and the same is represented by N_{iATWords}. Further, the parsing module 116 assigns a weightage, by assigning a weightage index, Wᵢ to the i^{th} sentence, wherein the weightage index Wᵢ is computed as per equation 3 provided below:

$${W}_{i} = \frac{1}{{N}_{iWords}} \qquad Equation 3$$

Thereafter, the classification and ranking module 118 determines the weighted probability of the i^{th} sentence being topical which is represented by WP_{iTD}. In one example, the WP_{iTD} is determined as per equation 4 provided below:

$${WP}_{iTD} = \frac{{N}_{iTWords} * {W}_{i}}{\sum {W}_{i}} \qquad Equation 4$$

Further, the classification and ranking module 118 determines the weighted probability of document being anti-topical which is represented by WP_{iATD}. In one example, the WP_{iATD} is determined as per equation 5 provided below:

$${WP}_{iATD} = \frac{{N}_{iATWords} * {W}_{i}}{\sum {W}_{i}} \qquad Equation 5$$

In one example, the classification and ranking module 118 computes the total weighted probability of the document being topical which is represented by WP_{TD}. In said example, the WP_{TD} is determined as per equation 6 provided below:

WP_{TD}=ΣWP_{iTD} Equation 6

In one example, the classification and ranking module 118 computes the total weighted probability of the document being anti-topical which is represented by WP_{ATD}. In one example, the WP_{ATD} is determined as per equation 7 provided below:

WP_{ATD}=ΣWP_{iATD} Equation 7

Thereafter, if the WP_{TD} is greater than the WP_{ATD}, then the classification and ranking module 118 determines the document to be topical. In case, the WP_{TD} is less than the WP_{ATD}, then the classification and ranking module 118 determines the document to be anti-topical. In one example, if the WP_{TD} and the WP_{ATD} are equal, then the classification and ranking module 118 may raise a flag indicating the user to decide whether the document is topical or anti-topical. In another example, the classification and ranking module 118 may perform analysis on a different constituent element of the document on the WP_{ATD} and the WP_{ATD} being equal.

In one example, the classification and ranking module 118 may further rank the documents, classified as topical, in an order of relevance based on a descending order of the difference between WP_{TD} and WP_{ATD}.

In another example, the parsing module 116 may classify the documents as one of topical and anti-topical based on paragraphs. In said example, the parsing module 116 determines the total number of paragraphs in the documents and the same is represented by N_{Paragraphs}. The parsing module 116 further determines the number of words that are in each paragraph. In one example, the number of words in the i^{th} paragraph is represented by N_{iPWords}. Further, the parsing module 116 further determines the number of sentences that are present in each paragraph. In one example, the number of sentences in the i^{th} paragraph is represented by N_{iPSentences}.

The parsing module 116 thereafter determines the number of topical words in the i^{th} paragraph, and the same is represented by N_{iPTWords}. The parsing module 116 also determines the number of anti-topical words in the i^{th} paragraph, and the same is represented by N_{iPATWords}. Further, the parsing module 116 assigns a weightage, by assigning a weightage index, W_{iP} to the i^{th} paragraph, wherein the weightage index W_{iP} is computed as per equation 8 provided below:

$${W}_{iP} = \frac{1}{{N}_{iPWords}} \qquad Equation 8$$

Thereafter, the classification and ranking module 118 determines the probability of the i^{th} paragraph being topical which is represented by P_{iPTD}. In one example, the P_{iPTD} is determined as per equation 9 provided below:

$${P}_{iPTD} = \frac{{N}_{iPTWords}}{{N}_{iPWords}} \qquad Equation 9$$

Further, the classification and ranking module 118 determines the weighted probability of document being anti-topical which is represented by P_{iPATD}. In one example, the P_{iPATD} is determined as per equation 10 provided below:

$${P}_{iAPTD} = \frac{{N}_{iPATWords}}{{N}_{iPWords}} \qquad Equation 10$$

Thereafter, the classification and ranking module 118 determines the weighted probability of the i^{th} paragraph being topical which is represented by WP_{iTD}. In one example, the WP_{iPTD} is determined as per equation 11 provided below:

$${WP}_{iPTD} = \frac{{N}_{iPTWords} * {W}_{iP}}{\sum {W}_{iP}} \qquad Equation 11$$

Further, the classification and ranking module 118 determines the weighted probability of document being anti-topical which is represented by WP_{iPATD}. In one example, the WP_{iPATD} is determined as per equation 12 provided below:

$${WP}_{iPATD} = \frac{{N}_{iPATWords} * {W}_{iP}}{\sum {W}_{iP}} \qquad Equation 12$$

In one example, the classification and ranking module 118 computes the total weighted probability of the document being topical which is represented by WP_{PTD}. In said example, the WP_{PTD} is determined as per equation 13 provided below:

WP_{PTD}=ΣWP_{iPTD} Equation 13

In one example, the classification and ranking module 118 computes the total weighted probability of the document being anti-topical which is represented by WP_{PATD}. In one example, the WP_{PATD} is determined as per equation 14 provided below:

WP_{PATD}=ΣWP_{iPATD} Equation 14

Thereafter, if the WP_{PTD} is greater than the WP_{PATD}, then the classification and ranking module 118 determines the document to be topical. In case, the WP_{PTD} is less than the WP_{PATD}, then the classification and ranking module 118 determines the document to be anti-topical. In one example, if the WP_{PTD} and the WP_{PATD} are equal, then the classification and ranking module 118 may raise a flag indicating the user to decide whether the document is topical or anti-topical. In another example, the classification and ranking module 118 may perform analysis on a different constituent element of the document on the WP_{PTD} and the WP_{PATD} being equal.

In another example, the classification and ranking module 118 may further rank the documents, classified as topical, in an order of relevance based on a descending order of the difference between the WP_{PTD} and the WP_{PATD}.

Thus, the document classification system 102 facilitates document classification of documents present in a repository based on topics to which the documents pertain. The document classification system 102, as described herein, provides different weightage to different constituent elements leading to enhanced accuracy in classification of documents.

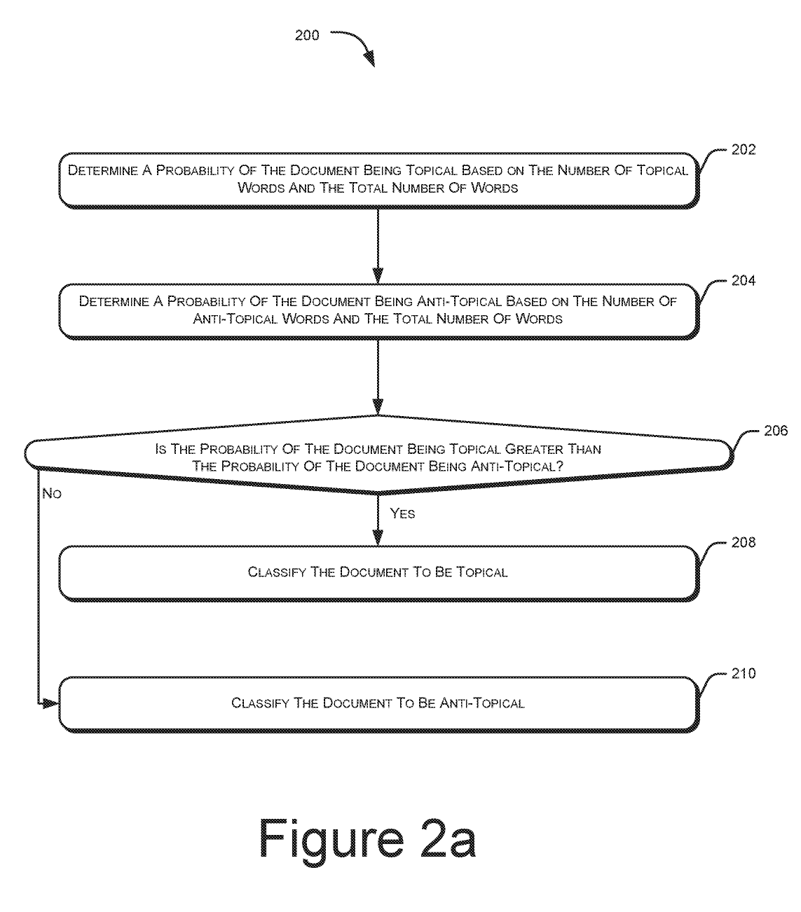

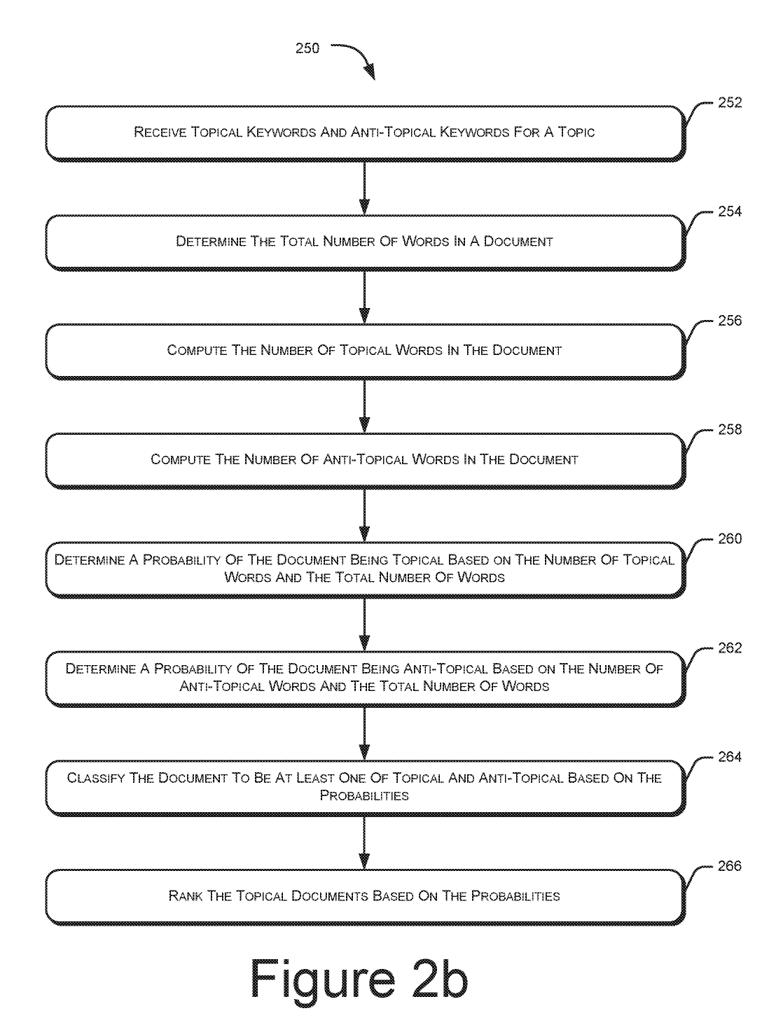

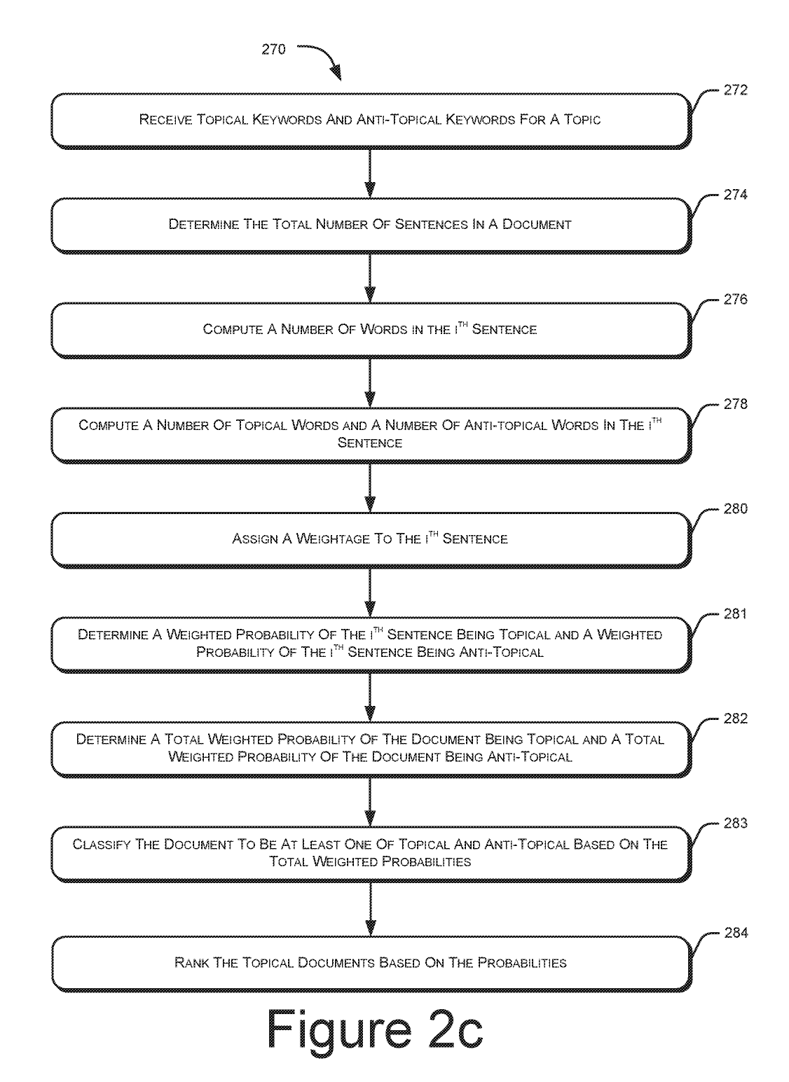

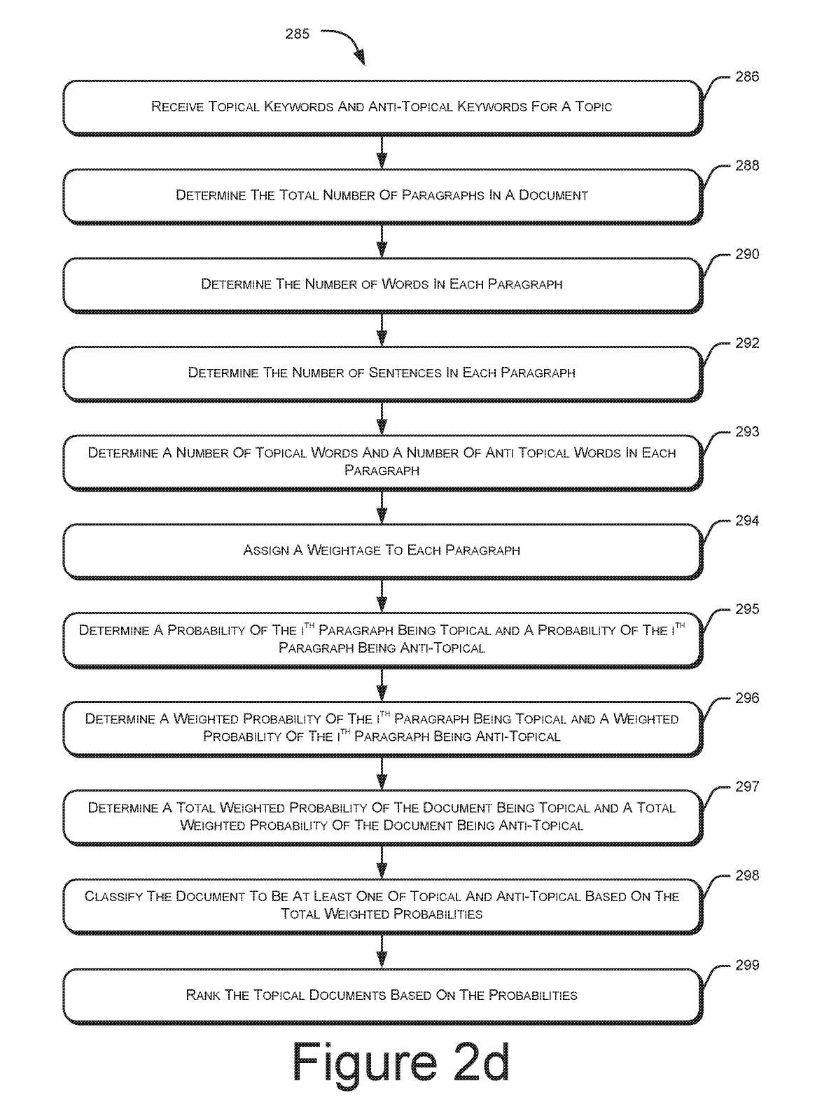

FIG. 2a, 2b, 2c and 2d illustrate methods 200, 250, 270 and 285 for document classification, according to an example of the present subject matter. The order in which the methods 200, 250, 270 and 285 are described is not intended to be construed as a limitation, and any number of the described method blocks can be combined in any order to implement the methods 200, 250, 270 and 285, or an alternative method. Additionally, individual blocks may be deleted from the methods 200, 250, 270 and 285 without departing from the spirit and scope of the subject matter described herein. Furthermore, the methods 200, 250, 270 and 285 may be implemented in any suitable hardware, computer-readable instructions, or combination thereof.

The steps of the methods 200, 250, 270 and 285 may be performed by either a computing device under the instruction of machine executable instructions stored on a storage media or by dedicated hardware circuits, microcontrollers, or logic circuits. Herein, some examples are also intended to cover program storage devices, for example, digital data storage media, which are machine or computer readable and encode machine-executable or computer-executable programs of instructions, where said instructions perform some or all of the steps of the described methods 200, 250, 270 and 285. The program storage devices may be, for example, digital memories, magnetic storage media, such as a magnetic disks and magnetic tapes, hard drives, or optically readable digital data storage media.

With reference to method 200 as depicted in FIG. 2a, as depicted in block 202, a probability of the document being topical is determined based on the number of topical words and the total number of words. In one example, the classification and ranking module 118 determines the probability of the document being topical.

As illustrated in block 204, a probability of the document being anti-topical is determined based on the number of anti-topical words and the total number of words. In one example, the classification and ranking module 118 determines the probability of the document being anti-topical.

At block 206, it is determined whether the probability of the document being topical is greater than the probability of the document being anti-topical. In one example, the classification and ranking module 118 determines whether the probability of the document being topical is greater than the probability of the document being anti-topical.

If at block 206, the probability of the document being topical is determined to be greater than the probability of the document being anti-topical, then as shown in block 208, the document is classified to be topical.

If at block 206, the probability of the document being topical is determined to be lesser than the probability of the document being anti-topical, then as shown in block 210, the document is classified to be anti-topical.

FIG. 2b illustrates a method 250 for document classification, according to another example of the present subject matter, wherein the constituent element is words. With reference to method 250 as depicted in FIG. 2b, topical keywords and anti-topical keywords for a topic are received from a user at block 252. In one example, the user may use the pattern identification module to identify topical keywords and anti-topical keywords by manually going through a small set of documents.

As illustrated in block 254, the total number of words in a document is determined. In one example, the parsing module 116 may determine the total number of words in the document.

As depicted in block 256, the number of topical words in the document is computed. In one example, the parsing module 116 may compute the total number of topical words present in the document based on the topical keywords identified by the user.

As shown in block 258, the number of anti-topical words in the document is computed. In one example, the parsing module 116 may compute the total number of anti-topical words present in the document based on the anti-topical keywords identified by the user.

At block 260, a probability of the document being topical is determined based on the number of topical words and the total number of words. In one example, the classification and ranking module 118 computes the probability of the document being topical.

As shown in block 262, a probability of the document being anti-topical is determined based on the number of anti-topical words and the total number of words. In one example, the classification and ranking module 118 computes the probability of the document being anti-topical.

As depicted in block 264, the document is classified to be at least one of topical and anti-topical based on the probabilities. In one example, the classification and ranking module 118 classifies the document to be one of topical and anti-topical based on the probabilities.

As shown in block 266, the topical documents are ranked, in an order of relevance, based on a difference between the probabilities. In one example, the classification and ranking module 118 ranks the documents, classified as topical, in an order of relevance based on a descending order of the difference between the probability of the document being topical and the probability of the document being anti-topical.

FIG. 2c illustrates a method 270 for document classification, according to another example of the present subject matter, wherein the constituent element is sentences. With reference to method 270 as depicted in FIG. 2c, topical keywords and anti-topical keywords for a topic are received from a user at block 272. In one example, the user may use the pattern identification module 114 to identify topical keywords and anti-topical keywords by manually going through a small set of documents.

As depicted in block 274, total number of sentences in a document is determined. In one implementation, the parsing module 116 determines the total number of sentences in the document and the same is represented by N_{Sentences}.

As shown in block 276, the number of words in each sentence, i.e. the i^{th} sentence, is determined. In one example, the parsing module 116 further determines the number of words that are present in each sentence. The number of words in the i^{th} sentence is represented by N_{iWords}.

As illustrated in block 278, a number of topical words and a number of anti-topical words in each sentence are determined. In one example, the parsing module 116 determines the number of topical words in the i^{th} sentence, and the same is represented by N_{iTWords}. Further, the parsing module 116 also determines the number of anti-topical words in the i^{th} sentence, and the same is represented by N_{iATWords}.

At block 280, a weightage is assigned to each sentence. In one example, the parsing module 116 assigns a weightage Wᵢ to the i^{th} sentence, wherein Wᵢ is computed as per the equation 3 which is reproduced below:

$${W}_{i} = \frac{1}{{N}_{iWords}} \qquad Equation 3$$

At block 281, a weighted probability of each sentence being topical and a weighted probability of each sentence being anti-topical is determined. In one example, the classification and ranking module 118 determines the weighted probability of the i^{th} sentence being topical which is represented by WP_{iTD}. In one example, the WP_{iTD} is determined as per equation 4 mentioned earlier. Further, the classification and ranking module 118 determines the weighted probability of document being anti-topical which is represented by WP_{iATD}. In one example, the WP_{iATD} is determined as per equation 5 mentioned earlier.

As illustrated in block 282, a total weighted probability of the document being topical and a total weighted probability of the document being anti-topical is determined. In one example, the classification and ranking module 118 determines the total weighted probability of the document being topical which is represented by WP_{TD}. In said example, the WP_{TD} is determined as per equation 6 mentioned earlier. Further, the classification and ranking module 118 computes the total weighted probability of the document being anti-topical which is represented by WP_{ATD}. In one example, the WP_{ATD} is determined as per equation 7 mentioned earlier.

At block 283, the document is classified into at least one of topical and anti-topical. In one example, if the WP_{TD} is greater than the WP_{ATD}, then the classification and ranking module 118 determines the document to be topical. In case, the WP_{TD} is less than the WP_{ATD}, then the classification and ranking module 118 determines the document to be anti-topical.

As shown in block 284, the topical documents are ranked, in an order of relevance, based on the difference between the WP_{TD} and WP_{ATD}. In one example, the classification and ranking module 118 ranks the documents, classified as topical, in an order of relevance based on a descending order of the difference between WP_{TD} and WP_{ATD}.

FIG. 2d illustrates a method 285 for document classification, according to another example of the present subject matter, wherein the constituent element is paragraphs. With reference to method 285 as depicted in FIG. 2c, topical keywords and anti-topical keywords for a topic are received from a user at block 286. In one example, the user may use the pattern identification module 114 to identify topical keywords and anti-topical keywords by manually going through a small set of documents.

At block 288, the number of paragraphs in the document is determined. In one example, the parsing module 116 determines the total number of paragraphs in the documents and the same is represented by N_{Paragraphs}.

At block 290, the number of words in each paragraph is determined. In one example, the parsing module 116 further determines the number of words that are in each paragraph. In one example, the number of words in the i^{th} paragraph is represented by N_{iPWords}.

At block 292, the number of sentences in each paragraph is determined. In one example, the parsing module 116 further determines the number of sentences that are present in each paragraph. In one example, the number of sentences in the i^{th} paragraph is represented by N_{iPSentences}.

At block 293, the number of topical words and the number of anti-topical words in each paragraph is determined. In one example, the parsing module 116 determines the number of topical words in the i^{th} paragraph, and the same is represented by N_{iPTWords}. The parsing module 116 also determines the number of anti-topical words in the i^{th} paragraph, and the same is represented by N_{iPATWords}.

At block 294, a weightage is assigned to each paragraph. Ine one example, the parsing module 116 assigns a weightage W_{iP} to the i^{th} paragraph, wherein W_{iP} is computed as per equation 8 reproduced below:

$${W}_{iP} = \frac{1}{{N}_{iPWords}} \qquad Equation 8$$

At block 295, a probability of the i^{th} paragraph being topical and a probability of the i^{th} paragraph being anti-topical is determined. In one example, the classification and ranking module 118 determines the probability of the i^{th} paragraph being topical which is represented by PTD. In one example, the P_{iPTD} is determined as per equation 9 mentioned earlier. Further, the ranking module 116 determines the weighted probability of document being anti-topical which is represented by P_{iPATD}. In one example, the P_{iPATD} is determined as per equation mentioned earlier.

At block 296, the weighted probability of the i^{th} paragraph being topical and the weighted probability of the i^{th} paragraph being anti-topical is determined. In one example, the classification and ranking module 118 determines the weighted probability of the i^{th} paragraph being topical which is represented by WP_{iTD}. In one example, the WP_{iPTD} is determined as per equation 11 mentioned earlier. Further, the ranking module 116 determines the weighted probability of document being anti-topical which is represented by WP_{iPATD}. In one example, the weighted probability is determined as per equation 12 mentioned earlier.

At block 297, the total weighted probability of the document being topical and the total weighed probability of the document being anti-topical is determined. In one example, the classification and ranking module 118 computes the total weighted probability of the document being topical which is represented by WP_{PTD}. In said example, the WP_{PTD} is determined as per equation 13 mentioned earlier. Further, the ranking module 116 computes the total weighted probability of the document being anti-topical which is represented by WP_{PATD}. In one example, the WP_{PATD} is determined as per equation 14 mentioned earlier.

At block 298, the document is classified into one of topical and anti-topical. In one example, if the WP_{PTD} is greater than the WP_{PATD}, then the classification and ranking module 118 determines the document to be topical. In case, the WP_{PTD} is less than the WP_{PATD}, then the classification and ranking module 118 determines the document to be anti-topical.

As shown in block 299, the topical documents are ranked, in an order of relevance, based on the difference between the WP_{PTD} and the WP_{PATD}. In one example, the classification and ranking module 118 ranks the documents, classified as topical, in an order of relevance based on a descending order of the difference between the WP_{PTD} and the WP_{PATD}.

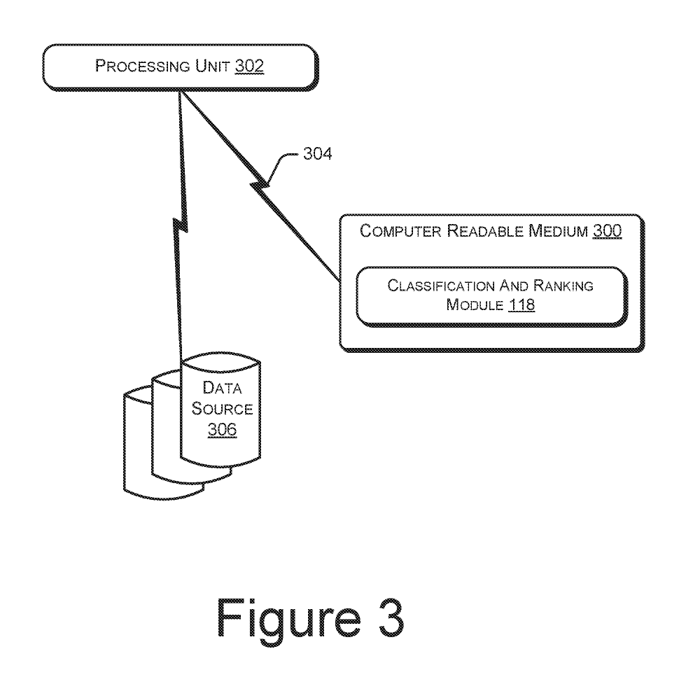

FIG. 3 illustrates a computer readable medium 300 storing instructions for document classification, according to an example of the present subject matter. In one example, the computer readable medium 300 is communicatively coupled to a processing unit 302 over communication link 304.

For example, the processing unit 302 can be a computing device, such as a server, a laptop, a desktop, a mobile device, and the like. The computer readable medium 300 can be, for example, an internal memory device or an external memory device, or any commercially available non transitory computer readable medium. In one implementation, the communication link 304 may be a direct communication link, such as any memory read/write interface. In another implementation, the communication link 304 may be an indirect communication link, such as a network interface. In such a case, the processing unit 302 can access the computer readable medium 300 through a network.

The processing unit 302 and the computer readable medium 300 may also be communicatively coupled to data sources 306 over the network. The data sources 306 can include, for example, databases and computing devices. The data sources 306 may be used by the requesters and the agents to communicate with the processing unit 302.

In one implementation, the computer readable medium 300 includes a set of computer readable instructions, such as the classification and ranking module 118. The set of computer readable instructions can be accessed by the processing unit 302 through the communication link 304 and subsequently executed to perform acts for document classification.

On execution by the processing unit 302, the classification and ranking module 118 computes a probability of a document being topical based on a number of constituent elements that are topical and a total number of constituent elements. The classification and ranking module 118 also computes a probability of the document being anti-topical based on a number of constituent elements that are anti-topical and the total number of constituent elements.

Thereafter, the classification and ranking module 118 determines whether the probability of the document being topical is greater than the probability of the document being anti-topical. The classification and ranking module 118 classifies the document as topical on determining the probability of the document being topical to be greater than the probability of the document being anti-topical.

Although implementations for document classification have been described in language specific to structural features and/or methods, it is to be understood that the appended claims are not necessarily limited to the specific features or methods described. Rather, the specific features and methods are disclosed as examples of systems and methods for document classification.

I/we claim:

1. A document classification system (102), for classification of documents based on topic to which the documents pertain, comprising:
a processor (106); and
a parsing module (116), coupled to the processor (106), to:
parse a document into its constituent elements, wherein the constituent elements is at least one of words, sentences and paragraphs;
determine a total number of constituent elements in the document;
determine a number of constituent elements that are topical based on topical patterns received from a user; and
determine a number of constituent elements that are anti-topical based on the key anti-topical patterns received from the user; and
a classification and ranking module (118), coupled to the processor (106), to:
compute a probability of the document being topical based on at least one of a probability of the constituent element being topical and the number of constituent elements that are topical and the total number of constituent elements;
compute a probability of the document being anti-topical based at least one of a probability of the constituent element being anti-topical and on the number of constituent elements that are anti-topical and the total number of constituent elements;
determine whether the probability of the document being topical is greater than the probability of the document being anti-topical; and
classify the document as topical on determining the probability of the document being topical to be greater than the probability of the document being anti-topical.

2. The document classification system (102) as claimed in claim 1, wherein the classification and ranking module (118) classifies the document as anti-topical on determining the probability of the document being topical to be less than the probability of the document being anti-topical.

3. The document classification system (102) as claimed in claim 1 further comprising a pattern identification module (114), coupled to the processor (106) to receive the topical patterns and the key anti-topical patterns from the user.

4. The document classification system (102) as claimed in claim 1, wherein the parsing module (116) further:
determines the number of words in the document;
determines a number of topical words in the document based on the topical key patterns received from the user; and
determines a number of anti-topical words in the document based on the anti-topical key patterns received from the user.

5. The document classification system (102) as claimed as claimed in claim 4, wherein the classification and ranking module (118) further:
computes a probability of the document being topical based on the number of topical words and the total number of words; and
computes a probability of the document being anti-topical based on the number of anti-topical words and the total number of words.

6. The document classification system (102) as claimed in claim 1, wherein the parsing module (116) further:
determines a number of sentences in the document;
determines a total number of words present in each sentence;
determines a number of topical words in the each sentence based on the topical key patterns received from the user; and
determines a number of anti-topical words in the each sentence based on the anti-topical key patterns received from the user.

7. The document classification system (102) as claimed in claim 6, wherein the classification and ranking module (118) further:
assigns a weightage index to the each sentence, indicative of the weightage assigned to the each sentence, based on the number of sentences in the document;
determines a weighted probability of the each sentence being topical based on the number of topical words in the each sentence;
determines a weighted probability of the each sentence being anti-topical based on the number of anti-topical words in the each sentence;
computes a total weighted probability of the document being topical based on summation of the weighted probability of the each sentence being topical;
computes a total weighted probability of the document being anti-topical based on summation of the weighted probability of the each sentence being anti-topical; and
classifies the document to be topical based on the total weighted probability of the document being topical being greater than the total weighted probability of the document being anti-topical.

8. The document classification system (102) as claimed in claim 1, wherein the parsing module (116) further:
determines a number of paragraphs in the document;
determines a total number of words present in each paragraph;
determines a number of topical words in the each paragraph based on the topical key patterns received from the user; and
determines a number of anti-topical words in the each paragraph based on the anti-topical key patterns received from the user.

9. The document classification system (102) as claimed in claim 8, wherein the classification and ranking module (118) further:
assigns a weightage index to the each paragraph, indicative of the weightage assigned to the each paragraph, based on the number of words in the each paragraph;
determines a weighted probability of the each paragraph being topical based on the number of topical words in the each sentence;
determines a weighted probability of the each paragraph being anti-topical based on the number of anti-topical words in the each sentence;
computes a total weighted probability of the document being topical based on summation of the weighted probability of the each paragraph being topical;
computes a total weighted probability of the document being anti-topical based on summation of the weighted probability of the each paragraph being anti-topical;
classifies the document to be topical on the total weighted probability of the document being topical being greater than the total weightage probability of the document being anti-topical.

10. A method for document classification, for classification of documents based on a topic to which the documents pertain, the method comprising:
computing a probability of a document being topical based on a number of constituent elements that are topical and a total number of constituent elements;
computing a probability of the document being anti-topical based on a number of constituent elements that are anti-topical and the total number of constituent elements;
determining whether the probability of the document being topical is greater than the probability of the document being anti-topical; and
classifying the document as topical on determining the probability of the document being topical to be greater than the probability of the document being anti-topical.

11. The method as claimed in claim 10, further comprising:
parsing a document into its constituent elements, wherein the constituent elements is at least one of words, sentences, and paragraphs;
determining the total number of constituent elements in the document;
determining the number of constituent elements that are topical based on topical patterns received from a user; and
determining a number of constituent elements that are anti-topical based on the key anti-topical patterns received from the user.

12. The method as claimed in claim 10, the method further comprising:
determining the number of words in the document;
determining a number of topical words in the document based on the topical key patterns received from the user;
determining a number of anti-topical words in the document based on the anti-topical key patterns received from the user;
computing a probability of the document being topical based on the number of topical words and the total number of words; and
computing a probability of the document being anti-topical based on the number of anti-topical words and the total number of words.

13. The method as claimed in claim 10, the method further comprising:
determining a number of sentences in the document;
determining a total number of words present in each sentence;
determining a number of topical words in the each sentence based on the topical key patterns received from the user;
determining a number of anti-topical words in the each sentence based on the anti-topical key patterns received from the user;
assigning a weightage index to the each sentence, indicative of the weightage assigned to the each sentence, based on the number of sentences in the document;
determining a weighted probability of the each sentence being topical based on the number of topical words in the each sentence;
determining a weighted probability of the each sentence being anti-topical based on the number of anti-topical words in the each sentence;
computing a total weightage probability of the document being topical based on summation of the weighted probability of the each sentence being topical;
computing a total weightage probability of the document being anti-topical based on summation of the weighted probability of the each sentence being anti-topical;
classifying the document to be topical on the total weightage probability of the document being topical being greater than the total weightage probability of the document being anti-topical; and
ranking the document based on a descending order of difference between the total weightage probability of the document being topical and the total weightage probability of the document being anti-topical.

14. The method as claimed in claim 6, the method further comprising:
determining a number of paragraphs in the document;
determining a total number of words present in each paragraph;
determining a number of topical words in the each paragraph based on the topical key patterns received from the user;
determining a number of anti-topical words in the each paragraph based on the anti-topical key patterns received from the user;
assigning a weightage index to the each paragraph, indicative of the weightage assigned to the each paragraph, based on the number of words in the each paragraph;
determining a weighted probability of the each paragraph being topical based on the number of topical words in the each sentence;
determining a weighted probability of the each paragraph being anti-topical based on the number of anti-topical words in the each sentence;
computing a total weightage probability of the document being topical based on summation of the weighted probability of the each paragraph being topical;
computing a total weightage probability of the document being anti-topical based on summation of the weighted probability of the each paragraph being anti-topical;
classifying the document to be topical on the total weightage probability of the document being topical being greater than the total weightage probability of the document being anti-topical; and
ranking the document based on a descending order of difference between the total weightage probability of the document being topical and the total weightage probability of the document being anti-topical.

15. A non-transitory computer-readable medium having a set of computer readable instructions that, when executed, cause a document classification system to:
compute a probability of a document being topical based on a number of constituent elements that are topical and a total number of constituent elements;
compute a probability of the document being anti-topical based on a number of constituent elements that are anti-topical and the total number of constituent elements;
determine whether the probability of the document being topical is greater than the probability of the document being anti-topical;
classify the document as topical on determining the probability of the document being topical to be greater than the probability of the document being anti-topical; and
classify the document as anti-topical on determining the probability of the document being topical to be lesser than the probability of the document being anti-topical
